(19) United States
(12) Patent Application Publication
(10) Pub. No.: US 2025/0184537 A1
(43) Pub. Date: Jun. 5, 2025

(54) FRACTION TRANSFORM FOR VIDEO CODING

(71) Applicant: BEIJING DAJIA INTERNET INFORMATION TECHNOLOGY CO., LTD., Beijing (CN)

(72) Inventors: Ning YAN, San Diego, CA (US); Xiaoyu XIU, San Diego, CA (US); Wei CHEN, San Diego, CA (US); Che-Wei KUO, San Diego, CA (US); Hong-Jheng JHU, San Diego, CA (US); Xianglin WANG, San Diego, CA (US); Bing YU, Beijing (CN)

(73) Assignee: BEIJING DAJIA INTERNET INFORMATION TECHNOLOGY CO., LTD., Beijing (CN)

(21) Appl. No.: 19/044,012

(22) Filed: Feb. 3, 2025

Related U.S. Application Data
(63) Continuation of application No. PCT/US2023/029668, filed on Aug. 7, 2023.
(60) Provisional application No. 63/395,818, filed on Aug. 6, 2022.

(51) Int. Cl. H04N 19/625; H04N 19/184

(52) U.S. Cl. CPC H04N 19/625; H04N 19/184

(57) ABSTRACT

The disclosure herein provides for methods, apparatuses and non-transitory computer-readable storage media for video decoding and encoding. In example, a method for video decoding, including: obtaining, by a decoder, enabling flags at a first level for at least one mode of intra and inter coding modes, the enabling flags indicating whether Fractional Discrete Cosine Transform (FRDCT) is enabled for the at least one mode; and in response to the FRDCT being enabled at the first level, obtaining, by the decoder, a second flag at a coding unit (CU) level to indicate whether a FRDCT transform is applied to a CU.

### CROSS-REFERENCE TO RELATED APPLICATIONS

The present application is a continuation application of PCT application No. PCT/US2023/029668 filed on Aug. 7, 2023, which is based upon and claims priority to U.S. Provisional Application No. 63/395,818, entitled “Fraction Transform for Video Coding,” filed on Aug. 6, 2022, both disclosures of which are incorporated by reference in their entireties for all purposes.

### TECHNICAL FIELD

The present disclosure is related to video coding and compression, and in particular but not limited to, methods and apparatus on improving the coding efficiency of transform coding.

### BACKGROUND

Various video coding techniques may be used to compress video data. Video coding is performed according to one or more video coding standards. For example, video coding standards include versatile video coding (VVC), high-efficiency video coding (H.265/HEVC), advanced video coding (H.264/AVC), moving picture expert group (MPEG) coding, or the like. Video coding generally utilizes prediction methods (e.g., inter-prediction, intra-prediction, or the like) that take advantage of redundancy present in video images or sequences. An important goal of video coding techniques is to compress video data into a form that uses a lower bit rate, while avoiding or minimizing degradations to video quality.

The first version of the VVC standard was finalized in July, 2020, which offers approximately 50% bit-rate saving or equivalent perceptual quality compared to the prior generation video coding standard HEVC. Although the VVC standard provides significant coding improvements than its predecessor, there is evidence that superior coding efficiency can be achieved with additional coding tools. Recently, Joint Video Exploration Team (JVET) under the collaboration of ITU-T VECG and ISO/IEC MPEG started the exploration of advanced technologies that can enable substantial enhancement of coding efficiency over VVC. In April 2021, one software codebase, called Enhanced Compression Model (ECM) was established for future video coding exploration work. The ECM reference software was based on VVC Test Model (VTM) that was developed by JVET for the VVC, with several existing modules (e.g., intra/inter prediction, transform, in-loop filter and so forth) are further extended and/or improved. In future, any new coding tool beyond the VVC standard need to be integrated into the ECM platform, and tested using JVET common test conditions (CTCs).

### SUMMARY

The present disclosure provides examples of techniques relating to improving the coding efficiency of the inter blocks.

A first example of the present disclosure includes a method for video encoding that includes generating, by an encoder, enabling flags at a sequence parameter set (SPS) level for intra and inter coding modes, the enabling flags indicating whether Fractional Discrete Cosine Transform (FRDCT) is enabled for at least one mode; in response to the FRDCT being enabled at the SPS level, generating, by the encoder, a FRDCT coding unit (CU) level flag to indicate whether a FRDCT transform is applied to a CU; in response to determining that the FRDCT transform is applied to the CU, obtaining a flag that indicates one of the following: (i) horizontal and vertical vectors share a FRDCT transform matrix, or (ii) horizontal and vertical vectors use separate FRDCT transform matrices.

A second example of the present disclosure, includes a method for video encoding that includes generating, by an encoder, enabling flags at a sequence parameter set (SPS) level for intra and inter coding modes, the enabling flags indicating whether the Fractional Discrete Cosine Transform (FRDCT) is enabled for at least one mode; in response to the FRDCT being enable at the SPS level, generating, by the encoder, a FRDCT coding unit (CU) level flag to indicate whether a FRDCT transform is applied to a CU; in response to determining that the FRDCT transform is applied to the CU, determining that the CU includes one of the following: (i) horizontal and vertical vectors sharing a FRDCT transform matrix; or (ii) horizontal and vertical vectors using separate FRDCT transform matrices.

A third example of the present disclosure, includes a method for video encoding that includes generating, at an encoder, a Fractional Discrete Cosine Transform (FRDCT) matrix using received video data; performing, at the encoder, an eigenvalue decomposition on the FRDCT matrix to obtain eigenvectors and eigenvalues the eigenvalue decomposition comprising: raising the eigenvalues to a power of a fractional number to obtain modified eigenvalues; and generating, at the encoder, a derived FRDCT matrix using the modified eigenvalues and eigenvectors.

A fourth example of the present disclosure, includes a method for video encoding that includes generating, at the encoder, a coding unit (CU) level flag to indicate that the FRDCT video coding scheme is enabled at a sequence parameter set (SPS) level; and in response to generating the CU level flag to indicate that the FRDCT video coding scheme is enabled at the SPS level, applying a Multiple Transform Skip (MTS) video coding scheme in place of the FRDCT video coding scheme in response to determining that a position of a last significant coefficient for a luma Transform Block (TB) is less than 1 or in response to determining that the last significant coefficient of a the luma TB is located inside an MTS zero-out region.

A fifth example of the present disclosure, includes a method for video decoding, that includes obtaining, at a decoder, a Fractional Discrete Cosine Transform (FRDCT) coding unit (CU) level flag; determining, at the decoder, that the FRDCT CU level flag indicates that a FRDCT transform parameter for horizontal and vertical FRDCT transforms is shared between the decoder and an encoder; and in response to determining that the FRDCT CU flag indicates that the FRDCT transform parameter for horizontal and vertical FRDCT transforms is shared between the decoder and encoder defining, at the decoder, the shared FRDCT transform parameter.

A sixth example of the present disclosure, includes a method for video decoding, that includes receiving, at a decoder, enabling flags at a sequence parameter set (SPS) level for intra and inter coding modes, the enabling flags indicating whether Fractional Discrete Cosine Transform (FRDCT) is enabled for at least one mode; determining, at the decoder, that a FRDCT coding unit (CU) level flag indicates a FRDCT transform parameter for horizontal and vertical FRDCT transforms is shared between the decoder and an encoder; defining, at the decoder, the shared FRDCT transform parameter, in response to determining that the FRDCT CU flag indicates that the FRDCT transform parameter for horizontal and vertical FRDCT transforms is shared between an encoder and the decoder; and receiving, at the decoder, one or more FRDCT transform matrices comprising an eigenvalue decomposition that satisfies both a DCT condition and an additive property, the one or more FRDCT transform matrices comprising the set of FRDCT transform parameters.

A seventh example of the present disclosure, includes a method for video decoding that includes receiving, at a decoder, a derived Fractional Discrete Cosine Transform (FRDCT) matrix generated by an encoder using eigen value decomposition comprising raising eigenvalues to a power of a fractional number to obtain modified eigenvalues, the FRDCT matrix comprising the modified eigenvalues; receiving, at the decoder, one or more encoded transformed blocks generated at the encoder by applying the derived FRDCT matrix to one or more video frames; and storing, at the decoder, the one or more encoded transformed blocks in memory

An eighth example of the present disclosure includes an apparatus for video decoding, that includes one or more processors; and a memory coupled to the one or more processors and configured to store instructions executable by the one or more processors, wherein the one or more processors, upon execution of the instructions, are configured to perform the methods in the aforementioned examples.

A ninth example of the present disclosure includes an apparatus for video encoding, comprising one or more processors; and a memory coupled to the one or more processors and configured to store instructions executable by the one or more processors, wherein the one or more processors, upon execution of the instructions, are configured to perform the method in any one of the aforementioned examples.

A tenth example of the present disclosure includes a non-transitory computer-readable storage medium for storing computer-executable instructions that, when executed by one or more computer processors, cause the one or more computer processors to receive a bitstream, and perform the method in any of the aforementioned examples based on the bitstream.

An eleventh example of the present disclosure includes a non-transitory computer-readable storage medium for storing computer-executable instructions that, when executed by one or more computer processors, cause the one or more computer processors to perform the method in any of the aforementioned example to encode the CU into a bitstream, and transmit the bitstream.

A twelfth example of the present disclosure includes a non-transitory computer-readable storage medium for storing a bitstream to be decoded by the method in any of the aforementioned examples.

A thirteenth example of the present disclosure includes a non-transitory computer-readable storage medium for storing a bitstream generated by the method in any of claims 1-19

### BRIEF DESCRIPTION OF THE DRAWINGS

A more particular description of the examples of the present disclosure will be rendered by reference to specific examples illustrated in the appended drawings. Given that these drawings depict only some examples and are not therefore considered to be limiting in scope, the examples will be described and explained with additional specificity and details through the use of the accompanying drawings.

FIG. 1 is a block diagram illustrating a system for encoding and decoding video blocks in accordance with some examples of the present disclosure.

FIG. 2 is a block diagram illustrating an exemplary video encoder in accordance with some examples of the present disclosure.

FIG. 3 is a block diagram illustrating an exemplary video decoder in accordance with some examples of the present disclosure.

FIG. 4A is an illustration of an encoded representation of a frame in accordance with some examples of the present disclosure.

FIG. 4B is an illustration of a CTU comprising one CTB of luma samples in accordance with some examples of the present disclosure.

FIG. 4C is an illustration of a 64×64 CTU divided into four smaller CUs, each having a block size of 32×32 in accordance with some examples of the present disclosure.

FIG. 4D is an illustration of a quad-tree data structure illustrating the end result of the partition process of the CTU 400 as depicted in FIG. 4C.

FIG. 4E is an illustration of five partitioning types of coding blocks having a width W and a height H, in accordance with some examples of the present disclosure.

FIG. 5 is a flow chart illustrating a method for video decoding in accordance with some examples of the present disclosure.

FIG. 6 is a flow chart illustrating a method for video decoding in accordance with some examples of the present disclosure.

FIG. 7 is a flow chart illustrating a method for video decoding in accordance with some examples of the present disclosure.

FIG. 8 is a flow chart illustrating a method for video decoding in accordance with some examples of the present disclosure.

FIG. 9 is a flow chart illustrating a method for video decoding in accordance with some examples of the present disclosure.

FIG. 10 is a flow chart illustrating a method for video decoding in accordance with some examples of the present disclosure.

FIG. 11 is a diagram illustrating a computing environment coupled with a user interface in accordance with some examples of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used. For example, it will be apparent to one of ordinary skill in the art that the subject matter presented herein can be implemented on many types of electronic devices with digital video capabilities.

Terms used in the disclosure are only adopted for the purpose of describing specific embodiments and not intended to limit the disclosure. “A/an,” “said,” and “the” in a singular form in the disclosure and the appended claims are also intended to include a plural form, unless other meanings are clearly denoted throughout the disclosure. It is also to be understood that term “and/or” used in the disclosure refers to and includes one or any or all possible combinations of multiple associated items that are listed.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

Throughout the disclosure, the terms “first,” “second,” “third,” etc. are all used as nomenclature only for references to relevant elements, e.g., devices, components, compositions, steps, etc., without implying any spatial or chronological orders, unless expressly specified otherwise. For example, a “first device” and a “second device” may refer to two separately formed devices, or two parts, components, or operational states of a same device, and may be named arbitrarily.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

As used herein, the term “if” or “when” may be understood to mean “upon” or “in response to” depending on the context. These terms, if appear in a claim, may not indicate that the relevant limitations or features are conditional or optional. For example, a method may comprise steps of: i) when or if condition X is present, function or action X′ is performed, and ii) when or if condition Y is present, function or action Y′ is performed. The method may be implemented with both the capability of performing function or action X′, and the capability of performing function or action Y′. Thus, the functions X′ and Y′ may both be performed, at different times, on multiple executions of the method.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

Reference will now be made in detail to specific implementations, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with digital video capabilities.

It should be illustrated that the terms “first,” “second,” and the like used in the description, claims of the present disclosure, and the accompanying drawings are used to distinguish objects, and not used to describe any specific order or sequence. It should be understood that the data used in this way may be interchanged under an appropriate condition, such that the embodiments of the present disclosure described herein may be implemented in orders besides those shown in the accompanying drawings or described in the present disclosure.

FIG. 1A is a block diagram illustrating an exemplary system 10 for encoding and decoding video blocks in parallel in accordance with some implementations of the present disclosure. As shown in FIG. 1A, the system 10 includes a source device 12 that generates and encodes video data to be decoded at a later time by a destination device 14. The source device 12 and the destination device 14 may comprise any of a wide variety of electronic devices, including desktop or laptop computers, tablet computers, smart phones, set-top boxes, digital televisions, cameras, display devices, digital media players, video gaming consoles, video streaming device, or the like. In some implementations, the source device 12 and the destination device 14 are equipped with wireless communication capabilities.

In some implementations, the destination device 14 may receive the encoded video data to be decoded via a link 16. The link 16 may comprise any type of communication medium or device capable of moving the encoded video data from the source device 12 to the destination device 14. In one example, the link 16 may comprise a communication medium to enable the source device 12 to transmit the encoded video data directly to the destination device 14 in real time. The encoded video data may be modulated according to a communication standard, such as a wireless communication protocol, and transmitted to the destination device 14. The communication medium may comprise any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other implementations, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may hold the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a File Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or a combination of both that is suitable for accessing encoded video data stored on a file server. The transmission of the encoded video data from the storage device 32 may be a streaming transmission, a download transmission, or a combination of both.

As shown in FIG. 1A, the source device 12 includes a video source 18, a video encoder 20 and the output interface 22. The video source 18 may include a source such as a video capturing device, e.g., a video camera, a video archive containing previously captured video, a video feeding interface to receive video from a video content provider, and/or a computer graphics system for generating computer graphics data as the source video, or a combination of such sources. As one example, if the video source 18 is a video camera of a security surveillance system, the source device 12 and the destination device 14 may form camera phones or video phones. However, the implementations described in the present application may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some implementations, the destination device 14 may include the display device 34, which can be an integrated display device and an external display device that is configured to communicate with the destination device 14. The display device 34 displays the decoded video data to a user, and may comprise any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present application is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

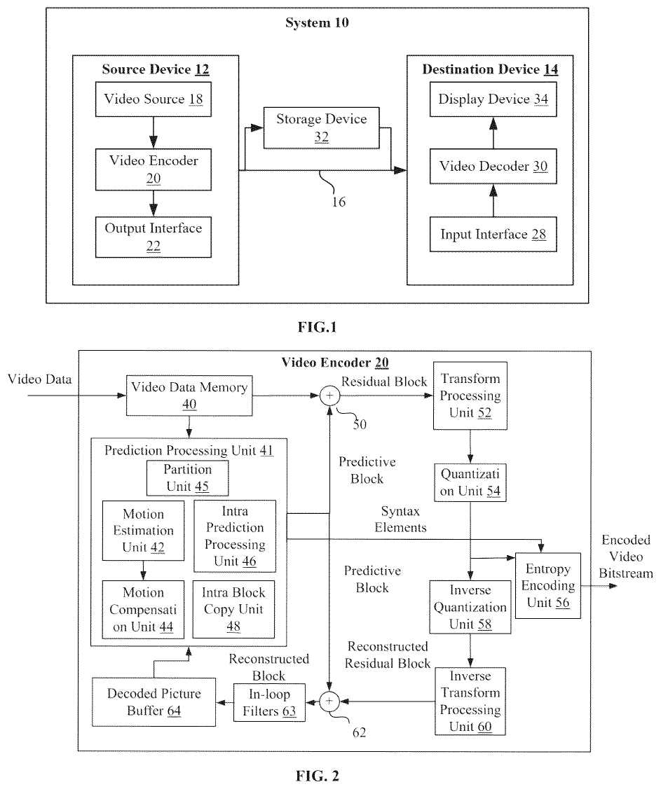

FIG. 2A is a block diagram illustrating an exemplary video encoder 20 in accordance with some implementations described in the present application. The video encoder 20 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. It should be noted that the term “frame” may be used as synonyms for the term “image” or “picture” in the field of video coding.

As shown in FIG. 2A, the video encoder 20 includes a video data memory 40, a prediction processing unit 41, a Decoded Picture Buffer (DPB) 64, a summer 50, a transform processing unit 52, a quantization unit 54, and an entropy encoding unit 56. The prediction processing unit 41 further includes a motion estimation unit 42, a motion compensation unit 44, a partition unit 45, an intra prediction processing unit 46, and an intra Block Copy (BC) unit 48. In some implementations, the video encoder 20 also includes an inverse quantization unit 58, an inverse transform processing unit 60, and a summer 62 for video block reconstruction. An in-loop filter 63, such as a deblocking filter, may be positioned between the summer 62 and the DPB 64 to filter block boundaries to remove blocky artifacts from reconstructed video. Another in-loop filter, such as Sample Adaptive Offset (SAO) filter and/or Adaptive in-Loop Filter (ALF), may also be used in addition to the deblocking filter to filter an output of the summer 62. In some examples, the in-loop filters may be omitted, and the decoded video block may be directly provided by the summer 62 to the DPB 64. The video encoder 20 may take the form of a fixed or programmable hardware unit or may be divided among one or more of the illustrated fixed or programmable hardware units.

The video data memory 40 may store video data to be encoded by the components of the video encoder 20. The video data in the video data memory 40 may be obtained, for example, from the video source 18 as shown in FIG. 1A. The DPB 64 is a buffer that stores reference video data (for example, reference frames or pictures) for use in encoding video data by the video encoder 20 (e.g., in intra or inter predictive coding modes). The video data memory 40 and the DPB 64 may be formed by any of a variety of memory devices. In various examples, the video data memory 40 may be on-chip with other components of the video encoder 20, or off-chip relative to those components.

As shown in FIG. 2A, after receiving the video data, the partition unit 45 within the prediction processing unit 41 partitions the video data into video blocks. This partitioning may also include partitioning a video frame into slices, tiles (for example, sets of video blocks), or other larger Coding Units (CUs) according to predefined splitting structures such as a Quad-Tree (QT) structure associated with the video data. The video frame is or may be regarded as a two-dimensional array or matrix of samples with sample values. A sample in the array may also be referred to as a pixel or a pel. A number of samples in horizontal and vertical directions (or axes) of the array or picture define a size and/or a resolution of the video frame. The video frame may be divided into multiple video blocks by, for example, using QT partitioning. The video block again is or may be regarded as a two-dimensional array or matrix of samples with sample values, although of smaller dimension than the video frame. A number of samples in horizontal and vertical directions (or axes) of the video block define a size of the video block. The video block may further be partitioned into one or more block partitions or sub-blocks (which may form again blocks) by, for example, iteratively using QT partitioning, Binary-Tree (BT) partitioning or Triple-Tree (TT) partitioning or any combination thereof. It should be noted that the term “block” or “video block” as used herein may be a portion, in particular a rectangular (square or non-square) portion, of a frame or a picture. With reference, for example, to HEVC and VVC, the block or video block may be or correspond to a Coding Tree Unit (CTU), a CU, a Prediction Unit (PU) or a Transform Unit (TU) and/or may be or correspond to a corresponding block, e.g. a Coding Tree Block (CTB), a Coding Block (CB), a Prediction Block (PB) or a Transform Block (TB) and/or to a sub-block.

The prediction processing unit 41 may select one of a plurality of possible predictive coding modes, such as one of a plurality of intra predictive coding modes or one of a plurality of inter predictive coding modes, for the current video block based on error results (e.g., coding rate and the level of distortion). The prediction processing unit 41 may provide the resulting intra or inter prediction coded block to the summer 50 to generate a residual block and to the summer 62 to reconstruct the encoded block for use as part of a reference frame subsequently. The prediction processing unit 41 also provides syntax elements, such as motion vectors, intra-mode indicators, partition information, and other such syntax information, to the entropy encoding unit 56.

In order to select an appropriate intra predictive coding mode for the current video block, the intra prediction processing unit 46 within the prediction processing unit 41 may perform intra predictive coding of the current video block relative to one or more neighbor blocks in the same frame as the current block to be coded to provide spatial prediction. The motion estimation unit 42 and the motion compensation unit 44 within the prediction processing unit 41 perform inter predictive coding of the current video block relative to one or more predictive blocks in one or more reference frames to provide temporal prediction. The video encoder 20 may perform multiple coding passes, e.g., to select an appropriate coding mode for each block of video data.

In some implementations, the motion estimation unit 42 determines the inter prediction mode for a current video frame by generating a motion vector, which indicates the displacement of a video block within the current video frame relative to a predictive block within a reference video frame, according to a predetermined pattern within a sequence of video frames. Motion estimation, performed by the motion estimation unit 42, is the process of generating motion vectors, which estimate motion for video blocks. A motion vector, for example, may indicate the displacement of a video block within a current video frame or picture relative to a predictive block within a reference frame relative to the current block being coded within the current frame. The predetermined pattern may designate video frames in the sequence as P frames or B frames. The intra BC unit 48 may determine vectors, e.g., block vectors, for intra BC coding in a manner similar to the determination of motion vectors by the motion estimation unit 42 for inter prediction, or may utilize the motion estimation unit 42 to determine the block vector.

A predictive block for the video block may be or may correspond to a block or a reference block of a reference frame that is deemed as closely matching the video block to be coded in terms of pixel difference, which may be determined by Sum of Absolute Difference (SAD), Sum of Square Difference (SSD), or other difference metrics. In some implementations, the video encoder 20 may calculate values for sub-integer pixel positions of reference frames stored in the DPB 64. For example, the video encoder 20 may interpolate values of one-quarter pixel positions, one-eighth pixel positions, or other fractional pixel positions of the reference frame. Therefore, the motion estimation unit 42 may perform a motion search relative to the full pixel positions and fractional pixel positions and output a motion vector with fractional pixel precision.

The motion estimation unit 42 calculates a motion vector for a video block in an inter prediction coded frame by comparing the position of the video block to the position of a predictive block of a reference frame selected from a first reference frame list (List 0) or a second reference frame list (List 1), each of which identifies one or more reference frames stored in the DPB 64. The motion estimation unit 42 sends the calculated motion vector to the motion compensation unit 44 and then to the entropy encoding unit 56.

Motion compensation, performed by the motion compensation unit 44, may involve fetching or generating the predictive block based on the motion vector determined by the motion estimation unit 42. Upon receiving the motion vector for the current video block, the motion compensation unit 44 may locate a predictive block to which the motion vector points in one of the reference frame lists, retrieve the predictive block from the DPB 64, and forward the predictive block to the summer 50. The summer 50 then forms a residual video block of pixel difference values by subtracting pixel values of the predictive block provided by the motion compensation unit 44 from the pixel values of the current video block being coded. The pixel difference values forming the residual video block may include luma or chroma difference components or both. The motion compensation unit 44 may also generate syntax elements associated with the video blocks of a video frame for use by the video decoder 30 in decoding the video blocks of the video frame. The syntax elements may include, for example, syntax elements defining the motion vector used to identify the predictive block, any flags indicating the prediction mode, or any other syntax information described herein. Note that the motion estimation unit 42 and the motion compensation unit 44 may be highly integrated, but are illustrated separately for conceptual purposes.

In some implementations, the intra BC unit 48 may generate vectors and fetch predictive blocks in a manner similar to that described above in connection with the motion estimation unit 42 and the motion compensation unit 44, but with the predictive blocks being in the same frame as the current block being coded and with the vectors being referred to as block vectors as opposed to motion vectors. In particular, the intra BC unit 48 may determine an intra-prediction mode to use to encode a current block. In some examples, the intra BC unit 48 may encode a current block using various intra-prediction modes, e.g., during separate encoding passes, and test their performance through rate-distortion analysis. Next, the intra BC unit 48 may select, among the various tested intra-prediction modes, an appropriate intra-prediction mode to use and generate an intra-mode indicator accordingly. For example, the intra BC unit 48 may calculate rate-distortion values using a rate-distortion analysis for the various tested intra-prediction modes, and select the intra-prediction mode having the best rate-distortion characteristics among the tested modes as the appropriate intra-prediction mode to use. Rate-distortion analysis generally determines an amount of distortion (or error) between an encoded block and an original, unencoded block that was encoded to produce the encoded block, as well as a bitrate (i.e., a number of bits) used to produce the encoded block. Intra BC unit 48 may calculate ratios from the distortions and rates for the various encoded blocks to determine which intra-prediction mode exhibits the best rate-distortion value for the block.

In other examples, the intra BC unit 48 may use the motion estimation unit 42 and the motion compensation unit 44, in whole or in part, to perform such functions for Intra BC prediction according to the implementations described herein. In either case, for Intra block copy, a predictive block may be a block that is deemed as closely matching the block to be coded, in terms of pixel difference, which may be determined by SAD, SSD, or other difference metrics, and identification of the predictive block may include calculation of values for sub-integer pixel positions.

Whether the predictive block is from the same frame according to intra prediction, or a different frame according to inter prediction, the video encoder 20 may form a residual video block by subtracting pixel values of the predictive block from the pixel values of the current video block being coded, forming pixel difference values. The pixel difference values forming the residual video block may include both luma and chroma component differences.

The intra prediction processing unit 46 may intra-predict a current video block, as an alternative to the inter-prediction performed by the motion estimation unit 42 and the motion compensation unit 44, or the intra block copy prediction performed by the intra BC unit 48, as described above. In particular, the intra prediction processing unit 46 may determine an intra prediction mode to use to encode a current block. To do so, the intra prediction processing unit 46 may encode a current block using various intra prediction modes, e.g., during separate encoding passes, and the intra prediction processing unit 46 (or a mode selection unit, in some examples) may select an appropriate intra prediction mode to use from the tested intra prediction modes. The intra prediction processing unit 46 may provide information indicative of the selected intra-prediction mode for the block to the entropy encoding unit 56. The entropy encoding unit 56 may encode the information indicating the selected intra-prediction mode in the bitstream.

After the prediction processing unit 41 determines the predictive block for the current video block via either inter prediction or intra prediction, the summer 50 forms a residual video block by subtracting the predictive block from the current video block. The residual video data in the residual block may be included in one or more TUs and is provided to the transform processing unit 52. The transform processing unit 52 transforms the residual video data into residual transform coefficients using a transform, such as a Discrete Cosine Transform (DCT) or a conceptually similar transform.

The transform processing unit 52 may send the resulting transform coefficients to the quantization unit 54. The quantization unit 54 quantizes the transform coefficients to further reduce the bit rate. The quantization process may also reduce the bit depth associated with some or all of the coefficients. The degree of quantization may be modified by adjusting a quantization parameter. In some examples, the quantization unit 54 may then perform a scan of a matrix including the quantized transform coefficients. Alternatively, the entropy encoding unit 56 may perform the scan.

Following quantization, the entropy encoding unit 56 entropy encodes the quantized transform coefficients into a video bitstream using, e.g., Context Adaptive Variable Length Coding (CAVLC), Context Adaptive Binary Arithmetic Coding (CABAC), Syntax-based context-adaptive Binary Arithmetic Coding (SBAC), Probability Interval Partitioning Entropy (PIPE) coding or another entropy encoding methodology or technique. The encoded bitstream may then be transmitted to the video decoder 30 as shown in FIG. 1A, or archived in the storage device 32 as shown in FIG. 1A for later transmission to or retrieval by the video decoder 30. The entropy encoding unit 56 may also entropy encode the motion vectors and the other syntax elements for the current video frame being coded.

The inverse quantization unit 58 and the inverse transform processing unit 60 apply inverse quantization and inverse transformation, respectively, to reconstruct the residual video block in the pixel domain for generating a reference block for prediction of other video blocks. As noted above, the motion compensation unit 44 may generate a motion compensated predictive block from one or more reference blocks of the frames stored in the DPB 64. The motion compensation unit 44 may also apply one or more interpolation filters to the predictive block to calculate sub-integer pixel values for use in motion estimation.

The summer 62 adds the reconstructed residual block to the motion compensated predictive block produced by the motion compensation unit 44 to produce a reference block for storage in the DPB 64. The reference block may then be used by the intra BC unit 48, the motion estimation unit 42 and the motion compensation unit 44 as a predictive block to inter predict another video block in a subsequent video frame.

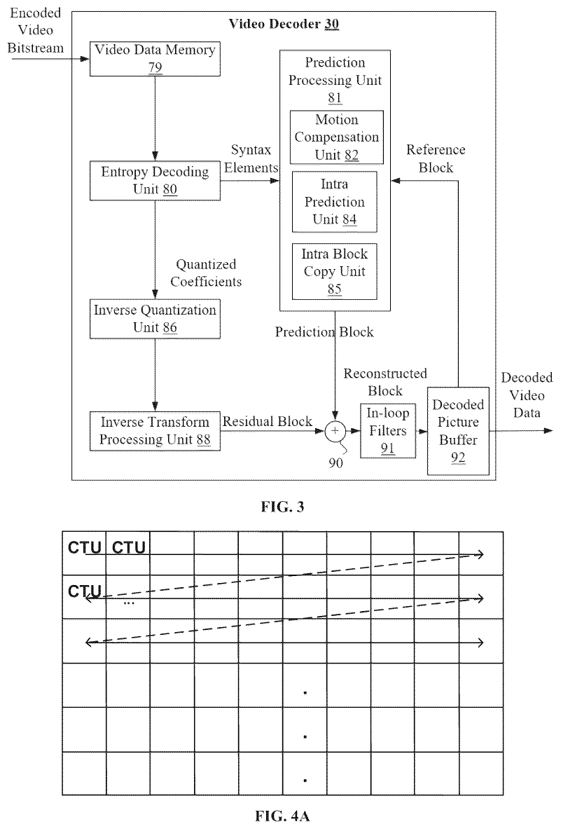

FIG. 3A is a block diagram illustrating an exemplary video decoder 30 in accordance with some implementations of the present application. The video decoder 30 includes a video data memory 79, an entropy decoding unit 80, a prediction processing unit 81, an inverse quantization unit 86, an inverse transform processing unit 88, a summer 90, and a DPB 92. The prediction processing unit 81 further includes a motion compensation unit 82, an intra prediction unit 84, and an intra BC unit 85. The video decoder 30 may perform a decoding process generally reciprocal to the encoding process described above with respect to the video encoder 20 in connection with FIG. 2A. For example, the motion compensation unit 82 may generate prediction data based on motion vectors received from the entropy decoding unit 80, while the intra-prediction unit 84 may generate prediction data based on intra-prediction mode indicators received from the entropy decoding unit 80.

In some examples, a unit of the video decoder 30 may be tasked to perform the implementations of the present application. Also, in some examples, the implementations of the present disclosure may be divided among one or more of the units of the video decoder 30. For example, the intra BC unit 85 may perform the implementations of the present application, alone, or in combination with other units of the video decoder 30, such as the motion compensation unit 82, the intra prediction unit 84, and the entropy decoding unit 80. In some examples, the video decoder 30 may not include the intra BC unit 85 and the functionality of intra BC unit 85 may be performed by other components of the prediction processing unit 81, such as the motion compensation unit 82.

The video data memory 79 may store video data, such as an encoded video bitstream, to be decoded by the other components of the video decoder 30. The video data stored in the video data memory 79 may be obtained, for example, from the storage device 32, from a local video source, such as a camera, via wired or wireless network communication of video data, or by accessing physical data storage media (e.g., a flash drive or hard disk). The video data memory 79 may include a Coded Picture Buffer (CPB) that stores encoded video data from an encoded video bitstream. The DPB 92 of the video decoder 30 stores reference video data for use in decoding video data by the video decoder 30 (e.g., in intra or inter predictive coding modes). The video data memory 79 and the DPB 92 may be formed by any of a variety of memory devices, such as dynamic random access memory (DRAM), including Synchronous DRAM (SDRAM), Magneto-resistive RAM (MRAM), Resistive RAM (RRAM), or other types of memory devices. For illustrative purpose, the video data memory 79 and the DPB 92 are depicted as two distinct components of the video decoder 30 in FIG. 3A. But it will be apparent to one skilled in the art that the video data memory 79 and the DPB 92 may be provided by the same memory device or separate memory devices. In some examples, the video data memory 79 may be on-chip with other components of the video decoder 30, or off-chip relative to those components.

During the decoding process, the video decoder 30 receives an encoded video bitstream that represents video blocks of an encoded video frame and associated syntax elements. The video decoder 30 may receive the syntax elements at the video frame level and/or the video block level. The entropy decoding unit 80 of the video decoder 30 entropy decodes the bitstream to generate quantized coefficients, motion vectors or intra-prediction mode indicators, and other syntax elements. The entropy decoding unit 80 then forwards the motion vectors or intra-prediction mode indicators and other syntax elements to the prediction processing unit 81.

When the video frame is coded as an intra predictive coded (I) frame or for intra coded predictive blocks in other types of frames, the intra prediction unit 84 of the prediction processing unit 81 may generate prediction data for a video block of the current video frame based on a signaled intra prediction mode and reference data from previously decoded blocks of the current frame.

When the video frame is coded as an inter-predictive coded (i.e., B or P) frame, the motion compensation unit 82 of the prediction processing unit 81 produces one or more predictive blocks for a video block of the current video frame based on the motion vectors and other syntax elements received from the entropy decoding unit 80. Each of the predictive blocks may be produced from a reference frame within one of the reference frame lists. The video decoder 30 may construct the reference frame lists, List 0 and List 1, using default construction techniques based on reference frames stored in the DPB 92.

In some examples, when the video block is coded according to the intra BC mode described herein, the intra BC unit 85 of the prediction processing unit 81 produces predictive blocks for the current video block based on block vectors and other syntax elements received from the entropy decoding unit 80. The predictive blocks may be within a reconstructed region of the same picture as the current video block defined by the video encoder 20.

The motion compensation unit 82 and/or the intra BC unit 85 determines prediction information for a video block of the current video frame by parsing the motion vectors and other syntax elements, and then uses the prediction information to produce the predictive blocks for the current video block being decoded. For example, the motion compensation unit 82 uses some of the received syntax elements to determine a prediction mode (e.g., intra or inter prediction) used to code video blocks of the video frame, an inter prediction frame type (e.g., B or P), construction information for one or more of the reference frame lists for the frame, motion vectors for each inter predictive encoded video block of the frame, inter prediction status for each inter predictive coded video block of the frame, and other information to decode the video blocks in the current video frame.

Similarly, the intra BC unit 85 may use some of the received syntax elements, e.g., a flag, to determine that the current video block was predicted using the intra BC mode, construction information of which video blocks of the frame are within the reconstructed region and should be stored in the DPB 92, block vectors for each intra BC predicted video block of the frame, intra BC prediction status for each intra BC predicted video block of the frame, and other information to decode the video blocks in the current video frame.

The motion compensation unit 82 may also perform interpolation using the interpolation filters as used by the video encoder 20 during encoding of the video blocks to calculate interpolated values for sub-integer pixels of reference blocks. In this case, the motion compensation unit 82 may determine the interpolation filters used by the video encoder 20 from the received syntax elements and use the interpolation filters to produce predictive blocks.

The inverse quantization unit 86 inverse quantizes the quantized transform coefficients provided in the bitstream and entropy decoded by the entropy decoding unit 80 using the same quantization parameter calculated by the video encoder 20 for each video block in the video frame to determine a degree of quantization. The inverse transform processing unit 88 applies an inverse transform, e.g., an inverse DCT, an inverse integer transform, or a conceptually similar inverse transform process, to the transform coefficients in order to reconstruct the residual blocks in the pixel domain.

After the motion compensation unit 82 or the intra BC unit 85 generates the predictive block for the current video block based on the vectors and other syntax elements, the summer 90 reconstructs decoded video block for the current video block by summing the residual block from the inverse transform processing unit 88 and a corresponding predictive block generated by the motion compensation unit 82 and the intra BC unit 85. An in-loop filter 91 such as deblocking filter, SAO filter and/or ALF may be positioned between the summer 90 and the DPB 92 to further process the decoded video block. In some examples, the in-loop filter 91 may be omitted, and the decoded video block may be directly provided by the summer 90 to the DPB 92. The decoded video blocks in a given frame are then stored in the DPB 92, which stores reference frames used for subsequent motion compensation of next video blocks. The DPB 92, or a memory device separate from the DPB 92, may also store decoded video for later presentation on a display device, such as the display device 34 of FIG. 1A.

In a typical video coding process, a video sequence typically includes an ordered set of frames or pictures. Each frame may include three sample arrays, denoted SL, SCb, and SCr. SL is a two-dimensional array of luma samples. SCb is a two-dimensional array of Cb chroma samples. SCr is a two-dimensional array of Cr chroma samples. In other instances, a frame may be monochrome and therefore includes only one two-dimensional array of luma samples.

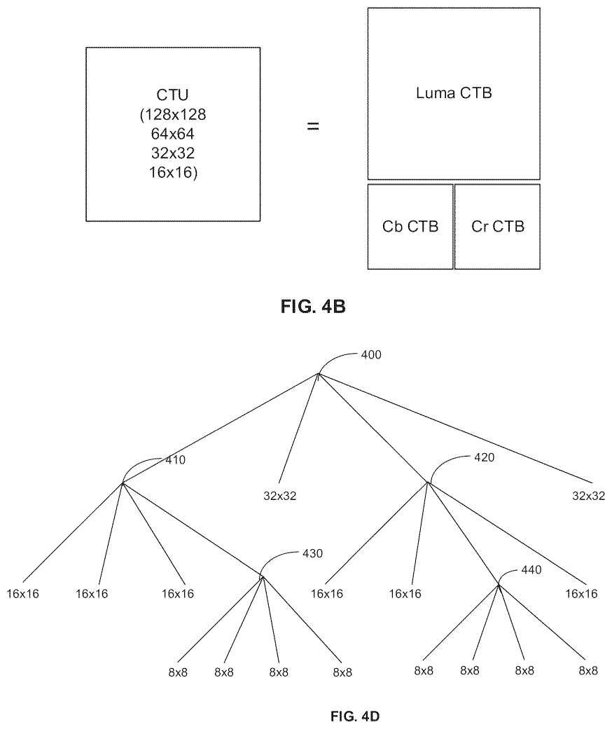

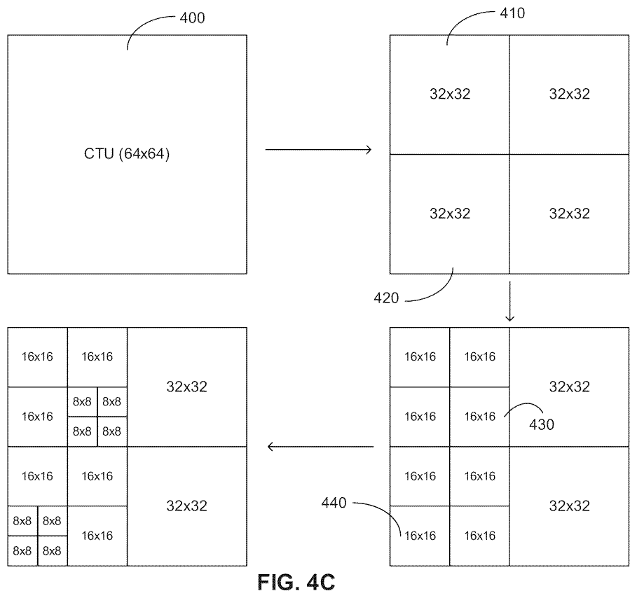

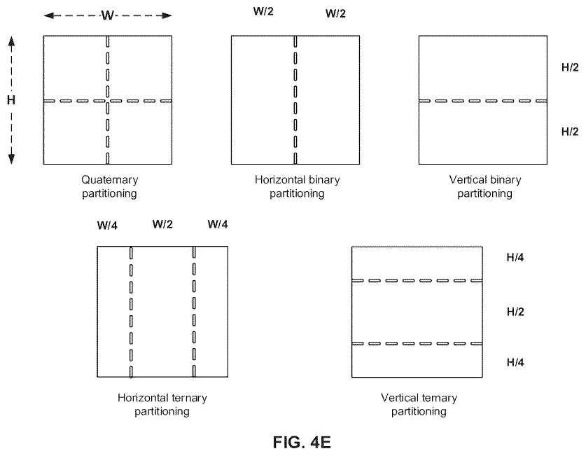

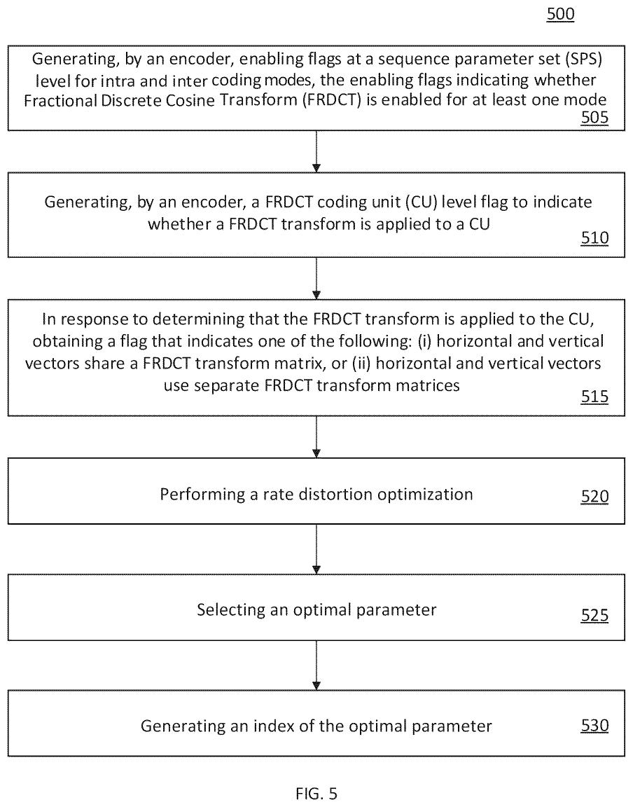

As shown in FIG. 4A, the video encoder 20 (or more specifically the partition unit 45) generates an encoded representation of a frame by first partitioning the frame into a set of CTUs. A video frame may include an integer number of CTUs ordered consecutively in a raster scan order from left to right and from top to bottom. Each CTU is a largest logical coding unit and the width and height of the CTU are signaled by the video encoder 20 in a sequence parameter set, such that all the CTUs in a video sequence have the same size being one of 128×128, 64×64, 32×32, and 16×16. But it should be noted that the present application is not necessarily limited to a particular size. As shown in FIG. 4B, each CTU may comprise one CTB of luma samples, two corresponding coding tree blocks of chroma samples, and syntax elements used to code the samples of the coding tree blocks. The syntax elements describe properties of different types of units of a coded block of pixels and how the video sequence can be reconstructed at the video decoder 30, including inter or intra prediction, intra prediction mode, motion vectors, and other parameters. In monochrome pictures or pictures having three separate color planes, a CTU may comprise a single coding tree block and syntax elements used to code the samples of the coding tree block. A coding tree block may be an N×N block of samples.

To achieve a better performance, the video encoder 20 may recursively perform tree partitioning such as binary-tree partitioning, ternary-tree partitioning, quad-tree partitioning or a combination thereof on the coding tree blocks of the CTU and divide the CTU into smaller CUs. As depicted in FIG. 4C, the 64×64 CTU 400 is first divided into four smaller CUs, each having a block size of 32×32. Among the four smaller CUs, CU 410 and CU 420 are each divided into four CUs of 16×16 by block size. The two 16×16 CUs 430 and 440 are each further divided into four CUs of 8×8 by block size. FIG. 4D depicts a quad-tree data structure illustrating the end result of the partition process of the CTU 400 as depicted in FIG. 4C, each leaf node of the quad-tree corresponding to one CU of a respective size ranging from 32×32 to 8×8. Like the CTU depicted in FIG. 4B, each CU may comprise a CB of luma samples and two corresponding coding blocks of chroma samples of a frame of the same size, and syntax elements used to code the samples of the coding blocks. In monochrome pictures or pictures having three separate color planes, a CU may comprise a single coding block and syntax structures used to code the samples of the coding block. It should be noted that the quad-tree partitioning depicted in FIGS. 4C and 4D is only for illustrative purposes and one CTU can be split into CUs to adapt to varying local characteristics based on quad/ternary/binary-tree partitions. In the multi-type tree structure, one CTU is partitioned by a quad-tree structure and each quad-tree leaf CU can be further partitioned by a binary and ternary tree structure. As shown in FIG. 4E, there are five possible partitioning types of a coding block having a width W and a height H, i.e., quaternary partitioning, horizontal binary partitioning, vertical binary partitioning, horizontal ternary partitioning, and vertical ternary partitioning.

In some implementations, the video encoder 20 may further partition a coding block of a CU into one or more M×N PBs. A PB is a rectangular (square or non-square) block of samples on which the same prediction, inter or intra, is applied. A PU of a CU may comprise a PB of luma samples, two corresponding PBs of chroma samples, and syntax elements used to predict the PBs. In monochrome pictures or pictures having three separate color planes, a PU may comprise a single PB and syntax structures used to predict the PB. The video encoder 20 may generate predictive luma, Cb, and Cr blocks for luma, Cb, and Cr PBs of each PU of the CU.

The video encoder 20 may use intra prediction or inter prediction to generate the predictive blocks for a PU. If the video encoder 20 uses intra prediction to generate the predictive blocks of a PU, the video encoder 20 may generate the predictive blocks of the PU based on decoded samples of the frame associated with the PU. If the video encoder 20 uses inter prediction to generate the predictive blocks of a PU, the video encoder 20 may generate the predictive blocks of the PU based on decoded samples of one or more frames other than the frame associated with the PU.

After the video encoder 20 generates predictive luma, Cb, and Cr blocks for one or more PUs of a CU, the video encoder 20 may generate a luma residual block for the CU by subtracting the CU's predictive luma blocks from its original luma coding block such that each sample in the CU's luma residual block indicates a difference between a luma sample in one of the CU's predictive luma blocks and a corresponding sample in the CU's original luma coding block. Similarly, the video encoder 20 may generate a Cb residual block and a Cr residual block for the CU, respectively, such that each sample in the CU's Cb residual block indicates a difference between a Cb sample in one of the CU's predictive Cb blocks and a corresponding sample in the CU's original Cb coding block and each sample in the CU's Cr residual block may indicate a difference between a Cr sample in one of the CU's predictive Cr blocks and a corresponding sample in the CU's original Cr coding block.

Furthermore, as illustrated in FIG. 4C, the video encoder 20 may use quad-tree partitioning to decompose the luma, Cb, and Cr residual blocks of a CU into one or more luma, Cb, and Cr transform blocks respectively. A transform block is a rectangular (square or non-square) block of samples on which the same transform is applied. A TU of a CU may comprise a transform block of luma samples, two corresponding transform blocks of chroma samples, and syntax elements used to transform the transform block samples. Thus, each TU of a CU may be associated with a luma transform block, a Cb transform block, and a Cr transform block. In some examples, the luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may comprise a single transform block and syntax structures used to transform the samples of the transform block.

The video encoder 20 may apply one or more transforms to a luma transform block of a TU to generate a luma coefficient block for the TU. A coefficient block may be a two-dimensional array of transform coefficients. A transform coefficient may be a scalar quantity. The video encoder 20 may apply one or more transforms to a Cb transform block of a TU to generate a Cb coefficient block for the TU. The video encoder 20 may apply one or more transforms to a Cr transform block of a TU to generate a Cr coefficient block for the TU.

After generating a coefficient block (e.g., a luma coefficient block, a Cb coefficient block or a Cr coefficient block), the video encoder 20 may quantize the coefficient block. Quantization generally refers to a process in which transform coefficients are quantized to possibly reduce the amount of data used to represent the transform coefficients, providing further compression. After the video encoder 20 quantizes a coefficient block, the video encoder 20 may entropy encode syntax elements indicating the quantized transform coefficients. For example, the video encoder 20 may perform CABAC on the syntax elements indicating the quantized transform coefficients. Finally, the video encoder 20 may output a bitstream that includes a sequence of bits that forms a representation of coded frames and associated data, which is either saved in the storage device 32 or transmitted to the destination device 14.

After receiving a bitstream generated by the video encoder 20, the video decoder 30 may parse the bitstream to obtain syntax elements from the bitstream. The video decoder 30 may reconstruct the frames of the video data based at least in part on the syntax elements obtained from the bitstream. The process of reconstructing the video data is generally reciprocal to the encoding process performed by the video encoder 20. For example, the video decoder 30 may perform inverse transforms on the coefficient blocks associated with TUs of a current CU to reconstruct residual blocks associated with the TUs of the current CU. The video decoder 30 also reconstructs the coding blocks of the current CU by adding the samples of the predictive blocks for PUs of the current CU to corresponding samples of the transform blocks of the TUs of the current CU. After reconstructing the coding blocks for each CU of a frame, video decoder 30 may reconstruct the frame.

As noted above, video coding achieves video compression using primarily two modes, i.e., intra-frame prediction (or intra-prediction) and inter-frame prediction (or inter-prediction). It is noted that IBC could be regarded as either intra-frame prediction or a third mode. Between the two modes, inter-frame prediction contributes more to the coding efficiency than intra-frame prediction because of the use of motion vectors for predicting a current video block from a reference video block.

But with the ever improving video data capturing technology and more refined video block size for preserving details in the video data, the amount of data required for representing motion vectors for a current frame also increases substantially. One way of overcoming this challenge is to benefit from the fact that not only a group of neighboring CUs in both the spatial and temporal domains have similar video data for predicting purpose but the motion vectors between these neighboring CUs are also similar. Therefore, it is possible to use the motion information of spatially neighboring CUs and/or temporally co-located CUs as an approximation of the motion information (e.g., motion vector) of a current CU by exploring their spatial and temporal correlation, which is also referred to as “Motion Vector Predictor (MVP)” of the current CU.

Instead of encoding, into the video bitstream, an actual motion vector of the current CU determined by the motion estimation unit 42 as described above in connection with FIG. 2A, the motion vector predictor of the current CU is subtracted from the actual motion vector of the current CU to produce a Motion Vector Difference (MVD) for the current CU. By doing so, there is no need to encode the motion vector determined by the motion estimation unit 42 for each CU of a frame into the video bitstream and the amount of data used for representing motion information in the video bitstream can be significantly decreased.

Like the process of choosing a predictive block in a reference frame during inter-frame prediction of a code block, a set of rules need to be adopted by both the video encoder 20 and the video decoder 30 for constructing a motion vector candidate list (also known as a “merge list”) for a current CU using those potential candidate motion vectors associated with spatially neighboring CUs and/or temporally co-located CUs of the current CU and then selecting one member from the motion vector candidate list as a motion vector predictor for the current CU. By doing so, there is no need to transmit the motion vector candidate list itself from the video encoder 20 to the video decoder 30 and an index of the selected motion vector predictor within the motion vector candidate list is sufficient for the video encoder 20 and the video decoder 30 to use the same motion vector predictor within the motion vector candidate list for encoding and decoding the current CU.

As explained in further detail herein, the Discrete Cosine Transform (DCT) is expanded to include the concept of a general fractional DCT. This extension allows for the derivation of a wide range of transform matrices with different fractional values. Instead of constricting the transform kernels to integer values, fractional values can be used to determine the transformational process. This allows for a more precise representation of the data and enables the derivation of a variety of transform matrices, each suited to specific types of signals or image content.

In this disclosure, DCT is extended to the general fractional DCT. Let Ca be a linear operator for a given fractional number a which maps N-dimensional vector s to another N-dimensional vector S_{α}=C_{α}s. C_{α} is defined as the FRDCT operator if the following conditions are satisfied: (1) C_{α} satisfies the DCT condition C₁=C; (2) C_{α} has the additive property C_{α+β}=C_{α}C_{β}; (3) C_{α} is real in the sense that s∈ [symbol] ^{N}⇒S_{α}∈ [symbol] ^{N} for all the α∈ [symbol] .

It is evident that the real power of the DCT matrix C can be used as the FRDCT operator, i.e., C_{α} C^{α}. To get the real power of the DCT matrix, the eigenvalue decomposition is considered. The fact that DCT matrix is unitary can assure that C has an orthonormal set of N eigenvectors uₙ, i.e., uₘ*uₙ=δₘₙ and the corresponding eigenvalues λₙ lie on the unit circle, i.e., λₙ=e^{jφ}^{ₙ} with φₙ real number. Therefore C can be decomposed in the following form:

$$C = U Λ {U}^{*} = {\sum }_{n} {U}_{n} {e}^{j {φ}_{n}}$$

Where Uₙ is a unitary matrix with uₙ as its column, Λ is the diagonal matrix with diagonal entries λₙ, and Uₙ=uₙuₘ* are unitary matrices which have the properties

$${U}_{m} {U}_{n} = {δ}_{mn} {U}_{m} and {\sum }_{n} {U}_{n} = I$$

In this disclosure, the eigenvalue decomposition is used to derive the FRDCT matrix by replacing the eigenvalues λₙ=e^{jφ}^{ₙ} with their α-th power λₙ^{α}, i.e., replacing the matrix Λ with its α-th power Λ^{α}. Then the FRDCT matrix can be written in the following form, which satisfies both the DCT conditions and the additive property.

C_{α}=UΛ^{α}U*

After defining the FRDCT matrix C_{α}, for any sequences s, the corresponding FRDCT S_{α} with fraction a can be calculated as.

S_{α}=C_{α}s

By the additive property, we have C_{-α}C_{α}=C₀=I so that the inverse FRDCT is obtained by using the matrix C_{-α}, namely

$$s = {C}_{- α} {S}_{α}$$

Some typical FRDCT matrices with different parameters are provided in Table 1 and Table 2 below as the examples of FRDCT matrices, including the 4×4 (Table 1) and 8×8 FRDCT (Table 2) matrices. It should be noted that more FRDCT matrices with different sizes and a parameters can be derived from equation above in the similar manner.

TABLE 1

| | |
|---|---|
| α = 0.5 | 0.768 0.299 −0.091 0.559 |
| | 0.242 0.660 0.328 −0.631 |
| | 0.559 −0.689 0.299 −0.351 |
| | −0.198 0.019 0.892 0.407 |
| α = 1.5 | 0.685 0.145 0.714 −0.008 |
| | 0.545 0.548 −0.634 0.024 |
| | −0.116 0.173 0.087 0.974 |
| | 0.469 −0.805 −0.284 0.224 |
| α = 3.0 | 0.462 0.309 0.462 0.691 |
| | 0.757 0.250 −0.021 −0.604 |
| | 0.462 −0.691 −0.462 0.309 |
| | 0.021 −0.604 0.757 −0.250 |
| α = 5.0 | 0.389 0.094 0.389 0.830 |
| | 0.803 0.210 0.231 −0.508 |
| | 0.389 −0.830 −0.389 0.094 |
| | −0.231 −0.508 0.803 −0.210 |
| α = 7.0 | 0.286 −0.128 0.286 0.906 |
| | 0.788 0.155 0.465 −0.374 |
| | 0.286 −0.906 −0.286 −0.128 |
| | −0.465 −0.374 0.788 −0.155 |

TABLE 2

| | |
|---|---|
| α = 0.5 | 0.703 0.314 −0.110 0.038 0.096 0.411 0.080 0.457 |
| | 0.068 0.743 0.435 0.121 0.170 −0.121 −0.094 −0.433 |
| | 0.492 −0.238 0.466 −0.078 −0.477 −0.490 −0.064 0.079 |
| | 0.351 −0.132 −0.391 0.393 0.076 −0.236 0.518 −0.471 |
| | 0.212 −0.367 0.121 0.209 0.717 −0.161 −0.471 0.013 |
| | −0.122 −0.237 0.459 0.664 −0.180 0.484 0.103 −0.009 |
| | 0.153 −0.281 0.344 −0.580 0.234 0.380 0.336 −0.361 |
| | −0.229 0.072 0.291 0.041 0.357 −0.341 0.606 0.495 |
| α = 1.5 | 0.576 −0.045 0.571 0.285 0.352 −0.026 0.358 −0.081 |
| | 0.606 0.567 −0.207 0.102 −0.299 −0.118 −0.386 −0.072 |
| | −0.070 0.588 0.180 −0.442 0.046 0.266 0.334 0.486 |
| | 0.057 −0.064 −0.037 0.243 0.222 0.860 −0.370 0.082 |
| | 0.158 −0.035 −0.634 0.196 0.530 −0.205 0.160 0.431 |
| | 0.418 −0.337 −0.368 −0.340 −0.336 0.328 0.459 −0.168 |
| | 0.052 −0.264 0.154 0.383 −0.555 −0.033 0.028 0.669 |
| | 0.301 −0.376 0.190 −0.594 0.184 −0.156 −0.487 0.290 |
| α = 3.0 | 0.320 0.199 0.257 0.240 0.287 0.308 0.403 0.629 |
| | 0.575 0.346 0.348 0.223 0.139 −0.003 −0.187 −0.570 |
| | 0.561 0.108 −0.096 −0.390 −0.452 −0.408 −0.126 0.355 |
| | 0.411 −0.307 −0.469 −0.354 0.140 0.442 0.322 −0.271 |
| | 0.261 −0.566 −0.178 0.348 0.420 −0.248 −0.429 0.191 |
| | 0.100 −0.562 0.386 0.263 −0.419 −0.174 0.475 −0.159 |
| | −0.018 −0.314 0.593 −0.471 0.013 0.398 −0.398 0.100 |
| | −0.075 −0.012 0.227 −0.451 0.568 −0.542 0.339 −0.090 |
| α = 5.0 | 0.260 0.066 0.186 0.107 0.198 0.159 0.308 0.850 |
| | 0.585 0.227 0.383 0.247 0.300 0.234 0.153 −0.481 |
| | 0.630 0.046 0.065 −0.291 −0.307 −0.504 −0.384 0.131 |
| | 0.342 −0.469 −0.404 −0.479 −0.022 0.264 0.431 −0.120 |
| | 0.078 −0.683 −0.008 0.267 0.528 −0.127 −0.399 0.043 |
| | −0.127 −0.457 0.601 0.099 −0.363 −0.300 0.419 −0.080 |
| | −0.194 −0.023 0.537 −0.671 0.204 0.315 −0.288 0.026 |
| | −0.130 0.213 −0.048 −0.287 0.570 −0.625 0.362 −0.077 |
| α = 7.0 | 0.191 −0.019 0.143 −0.010 0.139 −0.040 0.084 0.956 |
| | 0.520 0.095 0.374 0.169 0.355 0.350 0.498 −0.237 |
| | 0.650 0.014 0.239 −0.192 −0.053 −0.466 −0.495 −0.136 |
| | 0.234 −0.538 −0.314 −0.602 −0.164 −0.008 0.408 −0.029 |
| | −0.164 −0.680 0.089 0.140 0.633 −0.021 −0.279 −0.060 |
| | −0.335 −0.198 0.692 −0.005 −0.265 −0.429 0.336 −0.049 |
| | −0.267 0.315 0.302 −0.742 0.327 0.233 −0.160 −0.017 |
| | −0.071 0.315 −0.327 −0.031 0.497 −0.648 0.343 −0.060 |

In existing VVC and ECM designs, the Multilevel Transform Skip (MTS) is employed in the primary transform process. A specific MTS Coding Unit (CU) flag is used to indicate whether MTS should be applied. If the MTS CU flag is set to 0, the regular DCT2 is applied to both horizontal and vertical directions, representing the default behavior. However, if the MTS CU flag is set to 1, MTS is used, and the specific transform types for both horizontal and vertical directions are signaled separately.

To control the usage of FRDCT, similar to the MTS scheme, separate enabling flags are specified at the Sequence Parameter Set (SPS) level for intra and inter prediction, respectively. When FRDCT is enabled in the SPS, a CU-level flag is signaled to indicated whether FRDCT should be applied to the current CU.

The application of FRDCT can be specific to the luma (Y) component, the chroma (U and V) components, or both luma and chroma components, allowing for flexibility in the transform process based on characteristics of different video content. However, there are specific conditions under which the FRDCT signaling is skipped, and the regular (Discrete Cosine Transform) DCT2 is used instead. These conditions are as follows: (i) if the position of the last significant coefficient for the luma transform block (TB) is less than 1, indicating that only the DC coefficient is present in the block; and (2) if the last significant coefficient of the luma TB is located inside the MTS zero-out region, which is the region where primary transformed coefficients outside the Low Frequency Non-Significant Transform (LFNST) region are normatively zeroed out during the MTS process. In both cases, the application of FRDCT is avoided to prevent unnecessary computation and ensure that the transform process is optimized for the specific characteristics of the coding block.

If the FRDCT CU flag is set to zero, indicating that FRDCT is not applied, the regular DCT2 is used for both the horizontal and vertical directions.

By employing these enabling flags and conditional checks, the video codec can effectively control the usage of FRDCT, selectively applying it when beneficial and falling back to the regular DCT2 in other cases. This adaptability allows for improved compression efficiency and better preservation of video quality in various coding scenarios.

(A) MTS Replaced with FRDCT

In examples (A)(I-III), the existing MTS CU flag is replaced by an FRDCT CU flag. The FRDCT CU flag is introduced to indicate whether FRDCT should be used for a particular CU. Typical coding schemes use the MTS CU flag to indicate whether MTS should be applied by the encoder for the primary transform for a specific CU. The proposed approach introduces a new FRDCT CU flag that indicates whether the encoder intends to apply the FRDCT in the primary transform process (e.g., if the FRDCT CU flag is set to 1, the encoder intends to apply the FRDCT in the primary transform process for that specific CU or, if the FRDCT CU flag is set to 0, the encoder will not apply the FRDCT for that CU). Thus, the introduction of the FRDCT CU flag provides more flexibility and control over the transform process at the CU. By independently signaling the FRDCT CU flag for each CU, the encoder can adapt the transform scheme based on the specific characteristics and coding requirements of each CU. This allows for efficient utilization of both MTS and FRDCT, optimizing the compression efficiency and video quality for different coding scenarios.

FIG. 5 is an example of a method 500 in which the MTS is replaced with the FRDCT when the FRDCT CU flag is set to 1. The method 500 includes: generating, by an encoder, enabling flags at a sequence parameter set (SPS) level for intra and inter coding modes, the enabling flags indicating whether FRDCT is enabled for at least one mode, generating, by an encoder, a FRDCT CU level flag to indicate whether a FRDCT transform is applied to a CU, in response to determining that the FRDCT transform is applied to the CU, obtaining a flag that indicates one of the following: (i) horizontal and vertical vectors share a FRDCT transform matrix, or (ii) horizontal and vertical vectors use separate FRDCT transform matrices, performing a rate distortion optimization, and selecting an optimal parameter. By using the FRDCT CU flag to indicate whether FRDCT should be applied for a particular CU and sharing the same FRDCT parameter for both horizontal and vertical FRDCT transforms, the video codec achieves efficient transform selection and enhances compression performance and video quality for specific coding sequences.

At step 505, the method 500 includes generating, by an encoder, enabling flags at a sequence parameter set (SPS) level for intra and inter coding modes, the enabling flags indicating whether FRDCT is enabled for at least one mode. At step 510, the method 500 includes generating, by an encoder, a FRDCT CU level flag to indicate whether a FRDCT transform is applied to a CU.

At step 515, the method 500 includes in response to determining that the FRDCT transform is applied to the CU (e.g., determining that the FRDCT CU flag is set to 1), obtaining a flag that indicates one of the following: (i) horizontal and vertical vectors share a FRDCT transform matrix, or (ii) horizontal and vertical vectors use separate FRDCT transform matrices. For example, when the FRDCT CU flag is set to a first signal (indicating that FRDCT is enabled), the encoder and decoder use separate FRDCT parameters for horizontal and vertical FRDCT transforms. For example, when the FRDCT CU flag is set to a second signal (indicating that FRDCT is enabled), the encoder and decoder share the same FRDCT parameter a for horizontal and vertical FRDCT transforms).

At step 520, the method 500 includes performing a rate distortion optimization. By performing a rate distortion optimization, the encoder can adapt the transform process to a specific characteristic for each CU, thus ensuring that an optimal transform parameter at step 525 can be used to determine a balance between compression efficiency and video quality. In one example, the rate distortion optimization includes checking, at the encoder side, the K FRDCT parameters for each CU.

At step 525, the method 500 includes selecting the optimal parameter that optimizes compression efficiency and video quality for each CU. In one example, the encoder selects the FRDCT parameter that provides the best balance between compression efficiency and video quality. The encoder can use any type of criteria or metric to determine the optimal parameter that optimized the compression efficiency and video quality for each CU.

At step 530, the method 500 includes generating a signal index of the optimal FRDCT parameter. The index of the optimal FRDCT parameter is signaled in the bitstream, ensuring that the decoder has selected the optimal parameter for FRDCT. The decoder uses this information from the bitstream to correctly apply the specified horizontal and vertical FRDCT transforms during the decoding process for each CU.

For example, 8 FRDCT transforms are defined in addition to DCT2. The transform indices are binarized in the table below. In this example, 8 FRDCT transforms are defined, in addition to the traditional DCT2. Each FRDCT transform is assigned a unique index ranging from 0 to 7. To efficiently represent these indices in the bitstream, they are binarized using a 4-bit representation. A binarized transform indices for this example is provided in Table 3 below.

TABLE 3

| FRDCT CU flag | FRDCT index | Binarization |
|---|---|---|
| 0 | — | 0 |
| 1 | 0 | 1000 |
| | 1 | 1001 |
| | 2 | 1010 |
| | 3 | 1011 |
| | 4 | 1100 |
| | 5 | 1101 |
| | 6 | 1110 |
| | 7 | 1111 |

By using the binarization transform indices, the bitstream can efficiently convey the necessary information about the chosen FRDCT transforms for each CU, minimizing the overhead and allowing for more effective video coding. The decoder can then accurately apply the appropriate FRDCT transforms during the decoding process, ensuring efficient compression and high-quality video reconstruction.

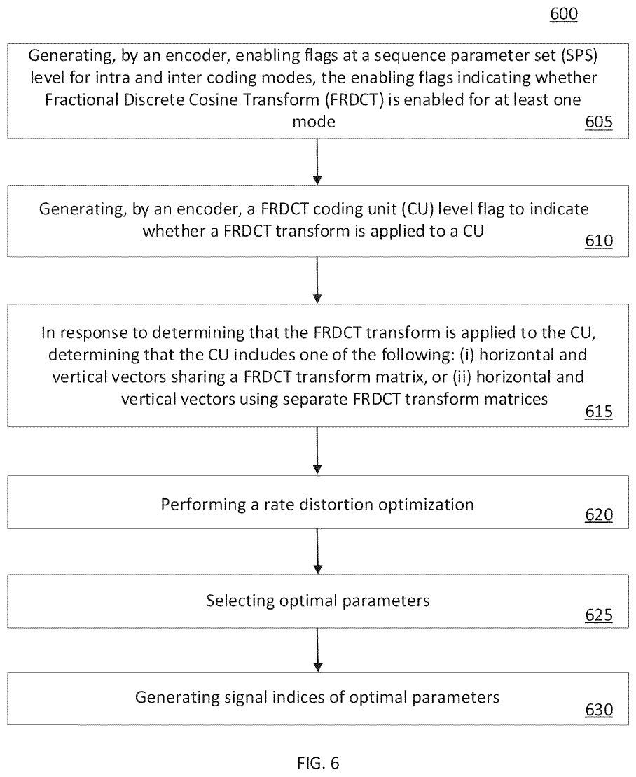

FIG. 6 is an example of a method 600, in which the encoder determines that the horizontal and vertical vectors either share a FRDCT transform matrix or use separate FRDCT transform matrices. The method 600 includes: generating, by an encoder, enabling flags at a sequence parameter set (SPS) level for intra and inter coding modes, the enabling flags indicating whether the Fractional Discrete Cosine Transform is enabled for at least one mode; in response to the FRDCT being enable at the SPS level, generating, by the encoder, a FRDCT coding unit (CU) level flag to indicate whether a FRDCT transform is applied to a CU; in response to determining that the FRDCT transform is applied to the CU, determining that the CU includes one of the following: (i) horizontal and vertical vectors sharing a FRDCT transform matrix; or (ii) horizontal and vertical vectors using separate FRDCT transform matrices; performing a rate distortion optimization; selecting optimal parameters; and generating an index of optimal parameters.

At step 605, the method 600 includes generating, by an encoder, enabling flags at a sequence parameter set (SPS) level for intra and inter coding modes, the enabling flags indicating whether the Fractional Discrete Cosine Transform is enabled for at least one mode;

At step 610, the method 600 includes in response to the FRDCT being enable at the SPS level, generating, by the encoder, a FRDCT coding unit (CU) level flag to indicate whether a FRDCT transform is applied to a CU. In one example, after receiving the FRDCT CU flag, the encoder checks the value of the FRDCT CU flag to determine whether to apply the FRDCT CU flag (e.g., if the FRDCT CU flag is equal to 1, then the FRDCT should be used for the CU and the encoder will apply the selected optimal FRDCT parameter according to step 625. If the FRDCT CU flag is equal to 0, the FRDCT should not be used by the CU). In one example, the decoder may receive and check the FRDCT CU flag and determine whether to apply the same selected optimal FRDCT parameter as the example above.

At step 615, the method 600 includes in response to determining that the FRDCT transform is applied to the CU, determining that the CU includes one of the following: (i) horizontal and vertical vectors sharing a FRDCT transform matrix; or (ii) horizontal and vertical vectors using separate FRDCT transform matrices. For example, when the FRDCT CU flag is set to a first signal (indicating that FRDCT is enabled), the encoder and decoder use separate FRDCT parameters for horizontal and vertical FRDCT transforms. For example, when the FRDCT CU flag is set to a second signal (indicating that FRDCT is enabled), the encoder and decoder share the same FRDCT parameter a for horizontal and vertical FRDCT transforms).

At step 620, the method 600 includes performing a rate distortion optimization at the encoder. At the encoder side for each CU, the K horizontal FRDCT parameters and M vertical FRDCT parameters are checked based on the rate distortion optimization. The optimization process aims to find the optimal parameters that maximize compression efficiency while preserving video quality.

At step 625, the method 600 includes selecting optimal parameters. The optimal horizontal FRDCT parameter and the optimal vertical FRDCT parameter that yields the best compression efficiency and video quality are selected for each CU.

At step 630, the method 600 includes generating indices of optimal parameters. The indices of the optimal horizontal and vertical FRDCT parameters are signaled in the bitstream, indicating which parameters to use for the horizontal and vertical FRDCT transforms respectively.

For example, Table 4 below provides the example binarization of the transform type in this embodiment. In this example, 1 FRDCT transform is defined in addition to DCT2, i.e., {DCT2, FRDCT} for both horizontal and vertical transforms.

TABLE 4

| FRDCT CU | Horizontal | Vertical | |
|---|---|---|---|
| flag | transform | transform | Binarization |
| 0 | DCT2 | DCT2 | 0 |
| 1 | DCT2 | FRDCT | 101 |
| | FRDCT | DCT2 | 110 |
| | FRDCT | FRDCT | 111 |

### (I) Intra Mode Dependent FRDCT

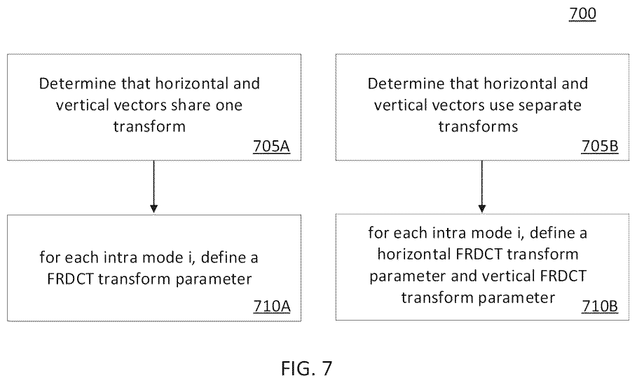

FIG. 7 is an example of a method 700 where the FRDCT parameter set is defined depending on the intra mode, i.e., different parameter sets for different intra modes. The proposed intra mode dependent FRDCT set can be applied to all the examples discussed above. For example, (at step 705A) if the horizontal FRDCT vector and vertical FRDCT vector share one transform, for each intra mode i, the FRDCT parameter is defined as {α₀, α₁, . . . , α_{K}_{ᵢ}₋₁} where Kᵢ is the number of FRDCT transforms (step 710A). For example, (at step 705B) if the horizontal FRDCT vector and vertical FRDCT vector use separate transforms, for each intra mode i, the horizontal and vertical FRDCT parameter is defined as {α₀, α₁, . . . , α_{K}_{ᵢ}₋₁} and {α₀, β₁, . . . , β_{M}_{ᵢ}₋₁} where Kᵢ and Mᵢ are the number of horizontal and vertical FRDCT transforms for intra mode i, respectively (at step 710B).

For example, in one aspect, the method for video encoding can include generating, by an encoder, enabling flags at a first level for at least one mode of intra and inter coding modes, the enabling flags indicating whether Fractional Discrete Cosine Transform (FRDCT) is enabled for the at least one mode. In response to the FRDCT being enabled at the first level, generating, by the encoder, a second flag at a coding unit (CU) level to indicate whether a FRDCT transform is applied to the CU, and determining a third flag based on the second flag, wherein the third flag indicates a usage of at least one FRDCT transform matrix for horizontal and vertical vectors. In one example, the first level includes the SPS level (e.g., a level that acts as initial configuration for the encoder and decoder).

For example, in one aspect the encoder can generate enabling flags at a first level for different coding modes (e.g., intra and inter coding modes). The enabling flags at the first level can be obtained/received by the decoder. If FRDCT is enabled at the first level for a particular coding mode, the encoder proceeds with generating a second flag at the CU level. Like the first flag, the second flag can be obtained/received by the decoder. Once the second flag is set at the CU level, the method can include generating, at the encoder, a third flag that indicates whether: (i) horizontal and vertical FRDCT vectors share a FRDCT transform matrix, or (ii) horizontal and vertical vectors use separate FRDCT transform matrices.

### (B) Using Both FRDCT and MTS

In one example, both the FRDCT and MTS are used in the primary transform process. To accommodate this dual usage, an additional FRDCT CU flag is introduced and signaled along with the existing MTS CU flag. The purpose of the FRDCT CU flag is to indicate whether FRDCT should be used for a particular CU, while the MTS CU flag continues to indicate whether MTS should be used. By signaling the FRDCT CU flag along with the MTS CU flag, the video encoder can determine whether to use a combination of both FRDCT and MTS in the primary transform for each CU. This provides the ability to adapt the transform scheme based on the characteristics of individual CUs, optimizing the coding efficiency and video quality for different coding scenarios.

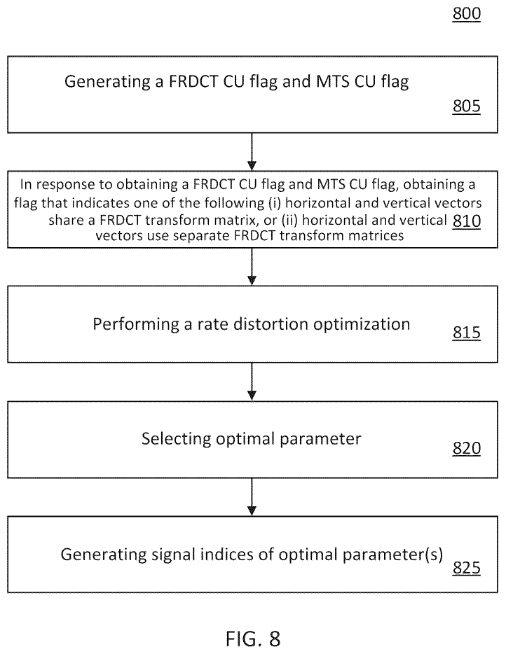

FIG. 8 is an example of a method 800 in which both the FRDCT and MTS are used in the primary transform process. The method 800 includes: generating a FRDCT CU flag and MTS CU flag; in response to obtaining a FRDCT CU flag and MTS CU flag, obtaining a flag that indicates one of the following: (i) horizontal and vertical vectors share a FRDCT transform matrix, or (ii) horizontal vectors use separate FRDCT transform matrices, performing a rate distortion optimization, selecting an optimal parameter, and indexing the optimal FRDCT parameter. By sharing the same FRDCT parameter for both horizontal and vertical FRDCT transforms, the video codec ensures consistency in the transform process, leading to improved coding efficiency and video quality.

At step 805, the method 800 includes generating a FRDCT CU flag and the MTS CU flag. The FRDCT CU flag and MTS CU flag are generated at the SPS level for intra and inter coding modes, the enabling flags indicating whether FRDCT and MTS are enabled for at least one mode.

At step 810, the method 800 includes in response to obtaining a FRDCT CU flag and MTS CU flag, obtaining a flag that indicates one of the following (i) horizontal and vertical vectors share a FRDCT transform matrix, or (ii) horizontal and vertical vectors use separate FRDCT transform matrices. During the encoding process, the values of the FRDCT CU flag and the MTS CU flag for each CU are checked by the encoder. Based on the values of the FRDCT CU flag the encoder determines whether to proceed with steps 815-825. For example: if both the FRDCT CU flag and the MTS CU flag are set to a first signal, the encoder may use both FRDCT and MTS, depending on the specific method being applied; if both the FRDCT CU flag and the MTS CU flag are set to a second signal, the encoder may choose a different transform method based on the video encoding scheme. In response to obtaining a FRDCT CU flag and MTS CU flag, the encoder obtains a flag that indicates that the horizontal and vertical vectors either share or use separate FRDCT transform matrices. It should be notes, that the decoder can also be configured to obtain/receive the flags herein, and perform the methods and steps disclosed herein.

At step 815, the method 800 includes performing a rate distortion optimization at the encoder. The encoder checks the FRDCT parameters for each coding unit for rate distortion optimization. The rate distortion optimization is used to determine the optimal parameter that maximizes the compression efficiency while preserving the video quality. In one example, a set of FRDCT parameters are considered for each CU.

At step 820, the method 800 includes selecting an optimal parameter. The encoder determines the optimal FRDCT parameter that yields the best trade-off between compression efficiency and video quality for each CU. By determining the optimal FRDCT parameter for each CU, the encoder can adapt the transform process to the characteristics of individual CUs. This can result in higher coding efficiency and improved video quality.

At step 825, the method 800 includes indexing the optimal FRDCT parameter. When both the MTS CU flag and the FRDCT flag are equal to 1 (indicating that both MTS and FRDCT are being used), the index of the optimal FRDCT parameter is signaled in the bitstream. This index points to the selected parameter in the FRDCT parameter set. For example, as shown in table 5 below 8 FRDCT transforms are defined in addition to DCT2, and binarized.

TABLE 5

| MTS CU | FRDCT CU | Horizontal | Vertical | |
|---|---|---|---|---|
| flag | flag | transform | transform | Binarization |
| 0 | — | DCT2 | DCT2 | 0 |
| 1 | 0 | DST7 | DST7 | 1000 |
| | | DCT8 | DST7 | 1001 |
| | | DST7 | DCT8 | 1010 |
| | | DCT8 | DCT8 | 1011 |
| | 1 | FRDCT-0 | FRDCT-0 | 11000 |
| | | FRDCT-1 | FRDCT-1 | 11001 |
| | | FRDCT-2 | FRDCT-2 | 11010 |
| | | FRDCT-3 | FRDCT-3 | 11011 |
| | | FRDCT-4 | FRDCT-4 | 11100 |
| | | FRDCT-5 | FRDCT-5 | 11101 |
| | | FRDCT-6 | FRDCT-6 | 11110 |
| | | FRDCT-7 | FRDCT-7 | 11111 |

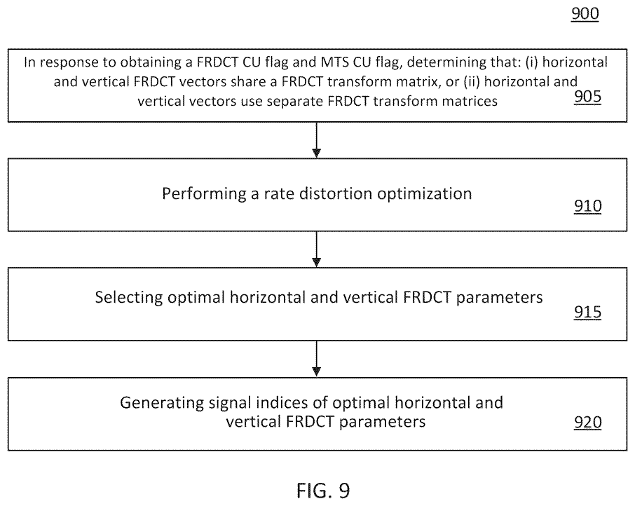

FIG. 9 is an example of a method 900 in which in response to obtaining a FRDCT CU flag, and MTS CU flag, determine that: (i) horizontal and vertical FRDCT vectors share a FRDCT transform matrix, or (ii) horizontal and vertical vectors use separate FRDCT transform matrices. The method 900 includes: determining that: horizontal and vertical FRDCT vectors either share or use separate FRDCT transform matrices; performing a rate distortion optimization; selecting optimal parameters; and indexing the optimal horizontal and vertical FRDCT parameters. By using separate FRDCT parameters for horizontal and vertical transforms, the video codec can adapt the transform process independently for each direction, potentially leading to improved compression efficiency and higher video quality in various coding scenarios.

At step 905, the method 900 includes in response to obtaining a FRDCT CU flag, and MTS CU flag, determining that: (i) horizontal and vertical FRDCT vectors share a FRDCT transform matrix, or (ii) horizontal and vertical vectors use separate FRDCT transform matrices. During the encoding process, the values of the FRDCT CU flag and the MTS CU flag for each CU are checked by the encoder. Based on the values of the FRDCT CU flag the encoder determines whether to proceed with steps 910-920.

At step 910, the method 900 includes performing a rate distortion optimization. At the encoder side, the horizontal FRDCT parameters and M vertical FRDCT parameters for each CU are checked based on rate distortion optimization. The optimization process aims to find the optimal parameters that maximize compression efficiency while preserving video quality.

At step 915, the method 900 includes determining the optimal horizontal and vertical FRDCT parameters that yield the best compression efficiency and video quality for each CU. For example, the encoder considers a set of horizontal FRDCT parameters and vertical FRDCT parameters and selects the horizontal and vertical FRDCT parameter that offers the best improved coding efficiency and video quality.

At step 920, the method 900 includes generating indexes for the optimal horizontal and vertical FRDCT parameters. When both the MTS CU flag and the FRDCT CU flag include a first signal, the indices of the optimal horizontal and vertical FRDCT parameters are signaled in the bitstream. The indices point to the selected parameters in the respective horizontal and vertical FRDCT parameter sets. The decoder uses this information from the bitstream to correctly apply the specified horizontal and vertical FRDCT transforms during the decoding process for each CU.

For example, Table 6 below provides an example binarization when 1 FRDCT transform defined in addition to DCT2, i.e., {DCT2, FRDCT} is used for both horizontal and vertical transforms.

TABLE 6

| MTS CU | FRDCT CU | Horizontal | Vertical | |
|---|---|---|---|---|
| flag | flag | transform | transform | Binarization |
| 0 | — | DCT2 | DCT2 | 0 |
| 1 | 0 | DST7 | DST7 | 1000 |
| | | DCT8 | DST7 | 1001 |
| | | DST7 | DCT8 | 1010 |
| | | DCT8 | DCT8 | 1011 |
| | 1 | DCT2 | FRDCT | 1101 |
| | | FRDCT | DCT2 | 1110 |
| | | FRDCT | FRDCT | 1111 |

### (I) Intra Mode Dependent FRDCT

When using both MTS and FRDCT, the selection of the FRDCT transform can also depend on the intra mode of the coding block. The use of intra modes further optimizes the FRDCT transform selection based on the characteristics of the coding block. For example, the method may include, in response to determining that a second flag indicates that the FRDCT transform is applied to the CU, obtaining a third flag that indicates one of the following: (i) horizontal and vertical vectors sharing a FRDCT transform matrix, or (ii) horizontal and vertical vectors using separate FRDCT transform matrices. In response to obtaining a third flag that indicates that horizontal and vertical vectors share a FRDCT transform matrix, determining by the encoder, a FRDCT transform parameter in response to a first intra mode of the CU where the same FRDCT transform matrix is shared by horizontal and vertical vectors. Alternatively or additionally, in response to obtaining a third flag that indicates that horizontal and vertical vectors use separate FRDCT transform matrices, determining by the encoder, a FRDCT transform parameter in response to a second intra mode of the CU, where different FRDCT transform matrices are used by horizontal and vertical vectors. The determination can be sent to the decoder. For example, the decoder can be configured to receive/obtain either a FRDCT transform parameter in response to an intra mode of the CU, or a horizontal FRDCT transform parameter and a vertical FRDCT transform parameter in response to an intra mode of the CU.

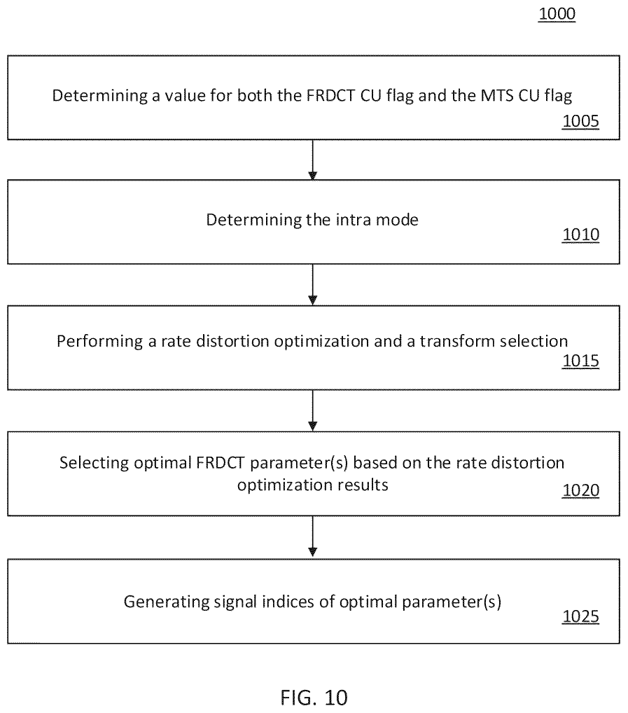

FIG. 10 is an example of a method 1000 in which the FRDCT parameter is set for each intra mode. In one example, the method includes: obtaining both a FRDCT CU flag and a MTS CU flag; in response to obtaining a FRDCT CU flag and MTS CU flag that indicates that FRDCT and MTS are enabled; determining an intra mode; obtaining a FRDCT CU flag, and MTS CU flag, determining that: (i) horizontal and vertical FRDCT vectors share a FRDCT transform matrix, or (ii) horizontal and vertical vectors use separate FRDCT transform matrices; performing a rate distortion optimization and transform selection; selecting optimal parameters; and signaling optimal FRDCT parameters. By using intra mode-dependent FRDCT sets, the video codec can adapt the transform process not only based on the overall characteristic of the coding block (utilizing MTS and FRDCT) but also based on the specific coding mode employed for intra prediction. This mode-dependent approach can lead to further improvements in compression efficiency and video quality for different intra modes, enhancing the overall coding performance of the video codec. For example, in one aspect of the present disclosure, the FRDCT parameter(s) are defined depending on the intra mode, i.e., different parameters for different intra modes (e.g., For intra mode i, the FRDCT parameter set is defined as {α₀, α₁, . . . , α_{K}_{ᵢ}₋₁} where Kᵢ is the number of FRDCT transforms in the set. For intra mode i, the horizontal and vertical FRDCT parameter set is defined as {α₀, α₁, . . . , α_{K}_{ᵢ}₋₁} and {β₀, β₁, . . . , β_{M}_{ᵢ}₋₁} where Kᵢ and Mᵢ are the number of horizontal and vertical FRDCT transforms in the sets for intra mode i, respectively).

At step 1005, the method 1000 includes obtaining a flag for both the FRDCT CU flag and the MTS CU flag. Based on the values of the FRDCT CU flag the encoder determines whether to proceed with steps 1015-1025. At step 1010, the method 1000 includes determining the intra mode.

At step 1010, the method 1000 includes defining a FRDCT parameter(s) for each intra mode. The number of parameters and their values in each set may vary depending on the characteristics of the coding block in a particular intra mode.

At step 1015, the method 1000 includes performing a rate distortion optimization and transform selection. For example, at this step, the encoder checks the FRDCT parameter(s) and performs a rate distortion optimization. The optimization aims to find the optimal parameter that maximizes compression efficiency while preserving video quality for that intra mode.

At step 1020, the method 1000 includes selecting optimal FRDCT parameter(s) from the intra mode-dependent FRDCT set for each CU and for each intra mode, based on the rate distortion optimization results.

At step 1025, the method 1000 includes indexing the optimal FRDCT parameter(s) for each intra mode in the bitstream. For example, when both the MTS CU flag and the FRDCT flag are equal to 1 (indicating that both MTS and FRDCT are being used), the encoder signals the indices of the optimal FRDCT parameters for each intra mode-dependent set in the bitstream. This allows the decoder to correctly apply the specified FRDCT transform with the chosen parameter for each CU and each intra mode during the decoding process.

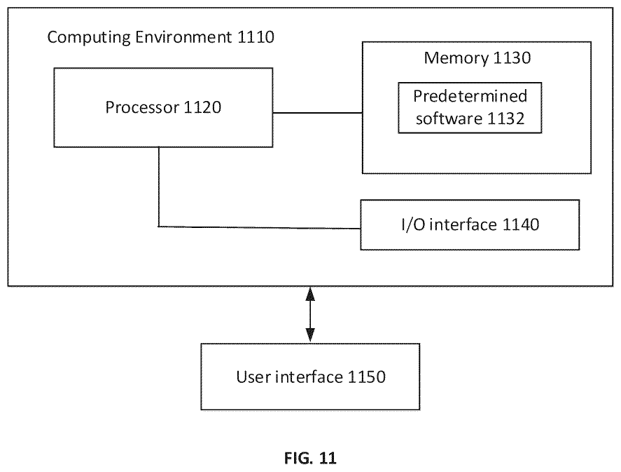

FIG. 11 shows a computing environment 1110 coupled with a user interface 1150. The computing environment 1110 can be part of a data processing server. The computing environment 1110 includes a processor 1120, a memory 1130, and an Input/Output (I/O) interface 1140.

The processor 1120 typically controls overall operations of the computing environment 1110, such as the operations associated with display, data acquisition, data communications, and image processing. The processor 1120 may include one or more processors to execute instructions to perform all or some of the steps in the above-described methods. Moreover, the processor 1120 may include one or more modules that facilitate the interaction between the processor 1120 and other components. The processor may be a Central Processing Unit (CPU), a microprocessor, a single chip machine, a Graphical Processing Unit (GPU), or the like.

The memory 1130 is configured to store various types of data to support the operation of the computing environment 1110. The memory 1130 may include predetermined software 1132. Examples of such data includes instructions for any applications or methods operated on the computing environment 1110, video datasets, image data, etc. The memory 1130 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The I/O interface 1140 provides an interface between the processor 1120 and peripheral interface modules, such as a keyboard, a click wheel, buttons, and the like. The buttons may include but are not limited to, a home button, a start scan button, and a stop scan button. The I/O interface 1140 can be coupled with an encoder and decoder.

In an embodiment, there is also provided a non-transitory computer-readable storage medium comprising a plurality of programs, for example, in the memory 1130, executable by the processor 1120 in the computing environment 1110, for performing the above-described methods. Alternatively, the non-transitory computer-readable storage medium may have stored therein a bitstream or a data stream comprising encoded video information (for example, video information comprising one or more syntax elements) generated by an encoder (for example, the video encoder 20 in FIG. 2) using, for example, the encoding method described above for use by a decoder (for example, the video decoder 30 in FIG. 3) in decoding video data. The non-transitory computer-readable storage medium may be, for example, a ROM, a Random Access Memory (RAM), a CD-ROM, a magnetic tape, a floppy disc, an optical data storage device or the like.

In an embodiment, the is also provided a computing device comprising one or more processors (for example, the processor 1120); and the non-transitory computer-readable storage medium or the memory 1130 having stored therein a plurality of programs executable by the one or more processors, wherein the one or more processors, upon execution of the plurality of programs, are configured to perform the above-described methods.

In an embodiment, there is also provided a computer program product comprising a plurality of programs, for example, in the memory 1130, executable by the processor 1120 in the computing environment 1110, for performing the above-described methods. For example, the computer program product may include the non-transitory computer-readable storage medium.

In an embodiment, the computing environment 1110 may be implemented with one or more ASICs, DSPs, Digital Signal Processing Devices (DSPDs), Programmable Logic Devices (PLDs), FPGAs, GPUs, controllers, micro-controllers, microprocessors, or other electronic components, for performing the above methods.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

Unless specifically stated otherwise, an order of steps of the method according to the present disclosure is only intended to be illustrative, and the steps of the method according to the present disclosure are not limited to the order specifically described above, but may be changed according to practical conditions. In addition, at least one of the steps of the method according to the present disclosure may be adjusted, combined or deleted according to practical requirements.

The examples were chosen and described in order to explain the principles of the disclosure and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

The above methods may be implemented using an apparatus that includes one or more circuitries, which include application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components. The apparatus may use the circuitries in combination with the other hardware or software components for performing the above described methods. Each module, sub-module, unit, or sub-unit disclosed above may be implemented at least partially using the one or more circuitries.

Other examples of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only.

It will be appreciated that the present disclosure is not limited to the exact examples described above and illustrated in the accompanying drawings, and that various modifications and changes can be made without departing from the scope thereof.

What is claimed is:

1. A method for video decoding, comprising:
obtaining, by a decoder, enabling flags at a first level for at least one mode of intra and inter coding modes, the enabling flags indicating whether Fractional Discrete Cosine Transform (FRDCT) is enabled for the at least one mode; and
in response to the FRDCT being enabled at the first level, obtaining, by the decoder, a second flag at a coding unit (CU) level to indicate whether a FRDCT is applied to a CU.

2. The method for video decoding of claim 1, further comprising:
in response to determining that the FRDCT is applied to the CU, determining, by the decoder, that the CU includes one of following:
horizontal and vertical vectors sharing a FRDCT transform matrix; or
horizontal and vertical vectors using separate FRDCT transform matrices.

3. The method for video decoding of claim 2, further comprising:
receiving, by the decoder, an index of optimal FRDCT transform parameter.

4. The method for video decoding of claim 2, further comprising:
receiving, by the decoder, an index of optimal horizontal FRDCT parameter and optimal vertical FRDCT transform parameter.

5. The method for video decoding of claim 1, further comprising:
obtaining, by the decoder, a third flag based on the second flag, wherein the third flag indicates a usage of at least one FRDCT transform matrix for horizontal or vertical vectors.

6. The method for video decoding of claim 5, wherein the first level is a sequence parameter set (SPS) level.

7. The method for video decoding of claim 6, wherein obtaining the third flag based on the second flag comprises:
in response to the second flag indicating that the FRDCT is applied to the CU, obtaining the third flag that indicates one of following:
horizontal and vertical vectors share a FRDCT transform matrix; or
horizontal and vertical vectors use separate FRDCT transform matrices.

8. The method for video decoding of claim 7, further comprising:
receiving, by the decoder, an index of optimal FRDCT transform parameters.

9. The method for video decoding of claim 7, further comprising:
receiving, by the decoder, an index of optimal horizontal FRDCT transform parameter and an index of optimal vertical FRDCT transform parameter.

10. The method for video decoding of claim 7, further comprising:
obtaining, by the decoder, a FRDCT transform parameter.

11. The method for video decoding of claim 7, further comprising:
obtaining, by the decoder, a horizontal FRDCT transform parameter and a vertical FRDCT transform parameter.

12. The method for video decoding of claim 1, further comprising:
in response to determining that the FRDCT is applied to the CU, determining, by the decoder, one of following:
horizontal and vertical vectors share a FRDCT transform matrix; or
horizontal and vertical vectors use separate FRDCT transform matrices.

13. The method for video decoding of claim 12, further comprising:
receiving, by the decoder, an index of optimal FRDCT transform parameter.

14. The method for video decoding of claim 12, further comprising:
receiving, by the decoder, an index of optimal horizontal FRDCT parameter and optimal vertical FRDCT transform parameter.

15. An apparatus for video decoding, comprising:
one or more processors; and
a memory coupled to the one or more processors and configured to store computer executable instructions that, when executed, cause the one or more processors to:
obtain enabling flags at a first level for at least one mode of intra and inter coding modes, the enabling flags indicating whether Fractional Discrete Cosine Transform (FRDCT) is enabled for the at least one mode; and
in response to the FRDCT being enabled at the first level, obtain a second flag at a coding unit (CU) level to indicate whether a FRDCT is applied to a CU.

16. The apparatus for video decoding of claim 15, wherein the computer executable instructions are further executed to cause the one or more processors to:
in response to determining that the FRDCT transform is applied to the CU, determine that the CU includes one of following:
horizontal and vertical vectors sharing a FRDCT transform matrix; or
horizontal and vertical vectors using separate FRDCT transform matrices.

17. The apparatus for video decoding of claim 16, wherein the computer executable instructions are further executed to cause the one or more processors to:
receive an index of optimal FRDCT transform parameter.

18. The apparatus for video decoding of claim 16, wherein the computer executable instructions are further executed to cause the one or more processors to:
receive an index of optimal horizontal FRDCT parameter and optimal vertical FRDCT transform parameter.

19. A non-transitory computer readable storage medium storing a bitstream to be decoded by the method for video decoding according to claim 1.
